(19) United States
(12) Patent Application Publication
(10) Pub. No.: US 2025/0365140 A1
(43) Pub. Date: Nov. 27, 2025

(54) QUANTUM KEY DISTRIBUTION PROTOCOL

(71) Applicant: Arqit Limited, London (GB)

(72) Inventors: Prakash Khaitan, Wiltshire (GB); Andrew Yeomans, London (GB)

(21) Appl. No.: 18/874,018

(22) PCT Filed: Jun. 14, 2023
(86) PCT No.: PCT/GB2023/051551

§ 371 Date: Dec. 11, 2024

(30) Foreign Application Priority Data
Jun. 17, 2022 (GB) 2208983.3

(51) Int. Cl. H04L 9/08; H04L 9/06

(52) U.S. Cl. CPC H04L 9/0858; H04L 9/0656

(57) ABSTRACT

A method for performing a quantum key distribution protocol among a first device, a second device, and an intermediary device (ID), the method including the ID transmitting a first secret symbol string to the first device via a quantum channel and a second secret symbol string to the second device via another quantum channel; the first and second devices demodulate their respective symbol strings and transmit reported symbol numbers to the ID; the ID shares basis state sets with both devices and generates a third symbol string by combining subsets of the first and second secret symbol strings corresponding to the reported symbol numbers; the ID transmits this third symbol string to the second device; and the first and second devices perform quantum key exchange by sifting validly received symbols in common positions.

The present application relates to a system, apparatus and method for quantum key distribution using a quantum key distribution protocol.

### BACKGROUND

Quantum key distribution (QKD) is a secure communication method which implements a cryptographic QKD protocol involving components of quantum mechanics for distributing cryptographic keys. It enables two parties to produce a shared random secret key or cryptographic key known only to them, which can then be used to encrypt and decrypt messages. The BB84 QKD protocol is a well-known QKD protocol using photon polarisation bases to transmit the information. The BB84 QKD protocol uses a set of bases including least two pairs of conjugate photon polarisation bases (e.g. a set of bases including, without limitation, for example a rectilinear photon basis (e.g. vertical) (0°) and horizontal (90°) polarisations) and diagonal photon basis (e.g. 45° and 135° polarisations) or the circular basis of left- and right-handedness etc.) In the BB84 protocol, QKD is performed between a sender device or intermediary device (e.g. referred to as Alice) and a receiver or first device (e.g. referred to as Bob or Carol). The sender device and receiver device are connected by a quantum communication channel which allows quantum information (e.g. quantum states) to be transmitted. The quantum channel may be, without limitation, for example, an optical fibre or optical free space. Furthermore, the sender device and receiver device also communicate over a non-quantum channel or public classical channel, without limitation, for example a fibre optic channel, telecommunications channel, radio channel, broadcast radio or the internet and/or any other wireless or wired communications channel and the like. Sheng-Kai Liao, et. al. “Satellite-to-ground quantum key distribution”, Nature volume 549, pages 43-47, 7 Sep. 2017, describes satellite-based QKD system using the BB84 protocol for distributing keys, where a satellite free-space optical quantum channel is produced using a 300-mm aperture Cassegrain telescope, which sends a light beam from a Micius satellite (e.g. Alice) to a ground station (e.g. Bob), which uses a Ritchey Chretien telescope for receiving the QKD photons over the satellite free-space optical quantum channel.

Although the security of the BB84 protocol comes from judicious use of the quantum and classical communication channels and authentication and the like, both the sender or intermediary device distributing the cryptographic key and the receiver device receiving the cryptographic key know the cryptographic key that the receiver device will eventually use. This means that the sender or intermediary device distributing the cryptographic key to the receiver device has to be a trusted device in a secure location in order for the receiver device to be able to trust that they may use the resulting cryptographic key. This may be fine should both the sender and receiver device use the resulting cryptographic key for cryptographic operations therebetween, e.g. for encrypted communications and the like with each other. However, if the sender or intermediary device is only distributing keys to one or more receiver devices in which the receiver devices may use the resulting cryptographic keys with one or more other receiver devices, then it is often not acceptable that the sender or intermediary device has access to the resulting cryptographic keys, this is an insecure system and cannot be trusted.

A solution to the above issue, termed the ARQ19 protocol (which is disclosed in GB2590064) is to allow a satellite and two end points (the sender and the receiver) to exchange quantum information such that the two endpoints share a symmetric key that is not known to the satellite. This overcame limitations with known satellite QKD methods (e.g. the BB84) where the satellite knows the key, and therefore is vulnerable to attack by a third-party. The ARQ19 protocol reduces information available at linking nodes by stopping the Quantum Receivers sharing their information with the linking node but rather using them in the post processing steps between the receivers without involving the linking party.

However, to increase the security of the system even further, a further reduction of the information available to the linking nodes is desired.

The embodiments described below are not limited to implementations which solve any or all of the disadvantages of the known approaches described above.

### SUMMARY

This Summary is provided to introduce a selection of concepts in a simplified form that are further described below in the Detailed Description. This Summary is not intended to identify key features or essential features of the claimed subject matter, nor is it intended to be used to determine the scope of the claimed subject matter; variants and alternative features which facilitate the working of the invention and/or serve to achieve a substantially similar technical effect should be considered as falling into the scope of the invention disclosed herein.

In a first aspect, the present disclosure provides a computer-implemented method of quantum key distribution between a first device and a second device, and an intermediary device, the method comprising steps of: transmitting, by the intermediary device, a first secret symbol string over a first quantum channel to the first device, wherein each symbol of the first secret symbol string is modulated by a basis state randomly selected from a set of bases; transmitting, by the intermediary device, a second secret symbol string over a second quantum channel to the second device, wherein each symbol of the second secret symbol string is modulated by a basis state randomly selected from the set of bases; demodulating, by the first device, the first secret symbol string, wherein each symbol of the first secret symbol string is demodulated by a basis state randomly selected from the set of bases; demodulating, by the second device, the second secret symbol string, wherein each symbol of the second secret symbol string is demodulated by a basis state randomly selected from the set of bases; transmitting, from the first device to the intermediary device over a first communication channel first reported symbol numbers, wherein the first reported symbol numbers comprise symbol numbers of symbols of the first secret symbol string that were successfully received by the first device, and symbol numbers of one or more symbols of the first secret symbol string that were not successfully received by the first device; transmitting from the second device to the intermediary device over a second communication channel symbol second reported symbol numbers, wherein the second reported symbol numbers comprise symbol numbers of the second secret symbol string that were successfully received by the second device, and symbol numbers of one or more symbols of the second secret symbol string that were not successfully received by the second device; transmitting from the intermediary device to the first device over the first communication channel a first basis state set corresponding to the first reported symbol numbers, the first basis sate set comprising the basis states used to modulate the symbols of the first secret symbol string, such that the first device can identify the validly received symbols from the first secret symbol string to produce a first validly received set of secret symbols; transmitting from the intermediary device to the second device over the second communication channel a second basis state set corresponding to the second reported symbol numbers, the second basis state comprising the basis states used to modulate the symbols of the second secret symbol string, such that the second device can identify the validly received symbols from the second secret symbol string to produce a second validly received set of secret symbols; generating, by the intermediary device, a third symbol string using the first secret symbol string and the second secret symbol string, wherein the third symbol string is generated by: generating a first set of secret symbols comprising symbols of the first secret symbol string that correspond to the first reported symbol numbers; generating a second set of secret symbols comprising symbols of the second secret symbol string that correspond to the second reported symbol numbers; and generating the third symbol string using the first set of secret symbols and the second set of secret symbols; transmitting from the intermediary device to the second device over the second communication channel the third symbol string, wherein the first device and the second device perform a quantum key exchange based on: generating, by the second device, a fourth set of secret symbols using the third symbol string and symbols corresponding to the second reported symbol numbers or the second validly received set of secret symbols, wherein the fourth set of secret symbols comprise the symbols of the first device that correspond the first reported symbol numbers; sharing, between the first and the second device over a third communication channel, symbol numbers of the validly received symbols of the received first and the second set of secret symbols; and performing a symbol sifting operation by the first device and second device, respectively, by identifying validly received symbols of the both devices that have a common symbol position, wherein the second device is able to infer, using the fourth set of secret symbols, the validly received symbols of the first device, such that both the first and the second device obtain identical symbols for forming a quantum key.

Preferably, a symbol is a bit.

Preferably, the intermediary device comprises two or more nodes.

Preferably, each node is configured to receive data from an adjacent node and/or the first or the second device.

Preferably, each node is configured to transmit data to an adjacent node and/or the first or the second device.

Preferably, the two or more nodes comprise: a first node which transmits the first secret symbol string and the first basis state set to the first device, and receives the first reported symbol numbers transmitted from the first device; and a second node which transmits the second secret symbol string, the second basis state set, and the third symbol string to the second device, receives the second reported symbol numbers transmitted from the second device, and generates the third symbol string; wherein the first node transmits the first set of secret symbols, or the first secret symbol string and the first reported symbol numbers, to the second node.

Preferably, the third symbol string is generated based on performing an XOR operation of symbols comprising the first set of secret symbols and the second set of secret symbols. Preferably, the third symbol string is generated based on performing a one-time pad encryption operations(s) of symbols comprising first set of secret symbols and the second set of secret symbols.

Preferably, wherein the third symbol string is generated based on performing an operation for obfuscating one or more symbols of the first set of secret symbols using the second set of secret symbols.

Preferably, the fourth set of secret symbols is generated based on performing an XOR operation of symbols comprising the third symbol string and the symbols corresponding to the second reported symbol numbers or the second validly received set of secret symbols.

Preferably, the fourth set of secret symbols is generated based on performing a one-time pad decryption operations(s) of symbols comprising the third symbol string and the symbols corresponding to the second reported symbol numbers or the second validly received set of secret symbols.

Preferably, the fourth set of secret symbols is generated based on performing an operation for extracting one or more symbols corresponding to the second reported symbol numbers or second validly received set of secret symbols using the third symbol string.

In a second aspect, the present disclosure provides a computer-implemented method of quantum key distribution between a first device and a second device, and an intermediary device, the method comprising steps of: transmitting, by the intermediary device, a first secret symbol string over a first quantum channel to the first device, wherein each symbol of the first secret symbol string is modulated by a basis state randomly selected from a set of bases; transmitting, by the intermediary device, a second secret symbol string over a second quantum channel to the second device, wherein each symbol of the second secret symbol string is modulated by a basis state randomly selected from a the set of bases; demodulating, by the first device, the first secret symbol string, wherein each symbol of the first secret symbol string is demodulated by a basis state randomly selected from the set of bases; demodulating, by the second device, the second secret symbol string, wherein each symbol of the second secret symbol string is demodulated by a basis state randomly selected from the set of bases; transmitting, from the first device to the intermediary device over a first communication channel first reported symbol numbers, wherein the first reported symbol numbers comprise symbol numbers of symbols of the first secret symbol string that were successfully received by the first device, and symbol numbers of one or more symbols of the first secret symbol string that were not successfully received by the first device; transmitting from the second device to the intermediary device over a second communication channel symbol second reported symbol numbers, wherein the second reported symbol numbers comprise symbol numbers of the second secret symbol string that were successfully received by the second device, and symbol numbers of one or more symbols of the second secret symbol string that were not successfully received by the second device; transmitting from the intermediary device to the first device over the first communication channel a first basis state set corresponding to the first reported symbol numbers, the first basis state set comprising the basis states used to modulate the symbols of the first secret symbol string, such that the first device can identify the validly received symbols from the first secret symbol string to produce a first validly received set of secret symbols; transmitting from the intermediary device to the second device over the second communication channel a second basis state set corresponding to the second reported symbol numbers, the second basis state set comprising the basis states used to modulate the symbols of the second secret symbol string, such that the second device can identify the validly received symbols from the second secret symbol string to produce a second validly received set of secret symbols, wherein the first and the second device use a shared symmetric key to generate common symbol positions to position their validly received symbols; transmitting, from the first device to the intermediary device via the first communication channel a third basis set, wherein the third basis state set comprises the basis states used to modulate the validly received symbols of the first secret symbol string, and one or more basis states corresponding to symbols from the first secret symbol string that were successfully received, but not validly received, and/or one or more basis states corresponding to symbols from the first secret symbol string that were not successfully received; transmitting from the second device to the intermediary device via the second communication channel a fourth basis state set, wherein the fourth basis state set comprises the basis states used to modulate the validly received symbols of the second secret symbol string, and one or more basis states corresponding to symbols from the second secret symbol string that were successfully received, but not validly received, and/or one or more basis states corresponding to symbols from the second secret symbol string that were not successfully received; generating, by the intermediary device, a third symbol string using the first secret symbol string and the second secret symbol string, wherein the third symbol string is generated by: generating a first set of secret symbols comprising symbols of the first secret symbol string that correspond to the third basis set; generating a second set of secret symbols comprising symbols of the second secret symbol string that correspond to fourth basis set; shifting the first and the second set of secret symbol to produce, respectively, a first and a second set of shifted secret symbols; and generating the third symbol string using the first and a second set of shifted secret symbols; and transmitting from the intermediary device to the second device over the second communication channel the third symbol string; and generating, by the second device, a fourth set of secret symbols using the third symbol string and the symbols corresponding to the fourth basis set or the second validly received set of secret symbols, wherein the second device is able to infer, using the fourth set of secret symbols, the symbols of the first device that correspond the third basis set, such that both the first and the second device obtain identical symbols for forming a quantum key.

Preferably, a symbol is a bit.

Preferably, the intermediary device comprises one or more nodes.

Preferably, each node is configured to receive data from an adjacent node and/or the first or the second device.

Preferably, each node is configured to transmit data to an adjacent node and/or the first or the second device.

Preferably, the two or more nodes comprise: a first node which transmits the first secret symbol string and the first basis state set to the first device, and receives the first reported symbol numbers and the third basis set transmitted from the first device; and a second node which transmits the second secret symbol string, the second basis state set, and the third symbol string to the second device, receives the second reported symbol numbers and the fourth basis set transmitted from the second device, and generates the third symbol string; wherein the first node transmits the first set of secret symbols, or the first symbol string and the third basis set, to the second node.

Preferably, the third symbol string is generated based on performing an XOR operation of symbols comprising the first set of shifted secret symbols and the second shifted set of secret symbols.

Preferably, the third symbol string is generated based on performing a one-time pad encryption operations(s) of symbols comprising first set of shifted secret symbols and the second set of shifted secret symbols.

Preferably, the third symbol string is generated based on performing any type operation for obfuscating one or more symbols of the first set of shifted secret symbols using the second set of shifted secret symbols.

Preferably, the fourth set of secret symbols is generated based on performing XOR operation of symbols comprising the third symbol string and the symbols corresponding to the fourth basis set or the second validly received set of secret symbol.

Preferably, the fourth set of secret symbols is generated based on performing a one-time pad decryption operations(s) of symbols comprising the third symbol string and the symbols corresponding to the fourth basis set or the second validly received set of secret symbols.

Preferably, the fourth set of secret symbols is generated based on performing any type operation for extracting one or more symbols corresponding to the third basis set or second validly received set of secret symbols using the third symbol string.

In a third aspect, the present disclose provides system comprising: an intermediary device; a first device; and a second device, where the intermediary device, first device and second device are configured to communicate with each other for establishing a shared a cryptographic key between the first and second devices.

Preferably, the intermediary device, first device, and the second device each comprise a processor unit, a memory unit, and a communication interface, the processor unit connected to the memory unit and the communication interface, wherein the processor unit, memory unit and communication interface are adapted to implement the computer-implemented method.

In a fourth aspect, the present disclosure provides a computer-readable medium comprising computer code or instructions stored thereon, which when executed on a processor, causes the processor to perform the computer-implemented method.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible (or non-transitory) storage media include disks, thumb drives, memory cards etc. and do not include propagated signals. The software can be suitable for execution on a parallel processor or a serial processor such that the method steps may be carried out in any suitable order, or simultaneously.

This application acknowledges that firmware and software can be valuable, separately tradable commodities. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example only and with reference to the following drawings, in which:

FIG. 1 is a schematic diagram illustrating an example QKD system for implementing an example QKD protocol according to the invention;

FIG. 2 is a schematic diagram illustrating an example QKD system of FIG. 1 with an additional intermediary node;

FIG. 3 is a schematic diagram illustrating an example QKD system for implementing an example extended QKD protocol according to the invention;

FIG. 4 is a flowchart illustrating the generation of a symmetric key for implementing an extended QKD protocol of FIG. 3;

FIG. 5 is a flowchart illustrating an example QKD process implemented using the system of FIG. 1; and

FIG. 6 is a flowchart illustrating an example QKD process implemented using the system of FIG. 3.

### DETAILED DESCRIPTION

The present invention provides an extension of the ARQ19 protocol, termed ARQ19-DRP (ARQ19-Decoy Receiver Protocol) in the present application. The present invention also provides a further extension to the ARQ19-DRP protocol, termed ARQ19-DRPE in the present application.

Embodiments of the present invention are described below by way of example only. These examples represent the best mode of putting the invention into practice that are currently known to the Applicant although they are not the only ways in which this could be achieved. The description sets forth the functions of the example and the sequence of step for constructing and operating the example. However, the same or equivalent functions and sequences may be accomplished by different examples.

The present disclosure provides method(s), apparatus and system(s) of quantum key distribution between a first device and a second device via an intermediary device using a quantum key distribution protocol. The quantum key distribution protocol enables the intermediary device to send randomly generated first and second secret symbol strings (e.g. n bit(s) per symbol are represented by M=2ⁿ different symbols, where n≥1) to the first device and second device, respectively, over respective quantum channels, and further processing of the first and second secret symbol strings is performed by the intermediary device via respective classical communication channels with the first and second devices, where the intermediary device generates a third symbol string for sending via a classical communication channel to the second device. The third symbol string is based on combining a set of symbols of the first secret symbol string with a set of symbols of the second secret symbol string in such a way that enables the second device to retrieve a fourth set of symbols based on using its received second symbol string. The combining of the set of symbols of the first secret symbol string and the set of symbols of the second secret symbol string may be based on, without limitation, for example one-time-pad encryption/decryption, masking, exclusive OR (XOR) operations on bits when symbols converted to bits, or extended XOR operations on symbols or obfuscated set of the first secret symbols.

In order to further reduce the information available to the intermediary device further, the first and the second device may inject errors in the locations of the symbols that they report back intermediary device. This is achieved by sending to the intermediary device the locations of the symbols that are not successfully detected (decoy received symbols), along with the locations of the successfully detected/received symbols. In the present application these are collectively termed the “received” symbols, which include the symbols that the first and the second device have successfully received, and symbols that they have not detected some (decoy received symbols), but are reported to the intermediary device as being successfully detected. Both devices record the symbol numbers of the decoy received symbols, which they will use in the later post-processing stages.

The second device is configured to perform a reverse set of operations to extract a fourth set of symbols using symbols from the received second secret symbol string (comprising successfully received and decoy received symbols). The symbols of the fourth set of symbols correspond to symbols of the first set of symbols. Neither the first device nor the second device send any information to the intermediary device that enables the intermediary device to know or determine exactly what the first and second devices successfully received or exactly which are decoy received symbols Thus, only the first and second devices fully know which symbols (or bits) of the first symbol string were successfully received by both the first and second devices, and which are the decoy received symbols. This information is not shared with the intermediary device. From this, the first and second devices may perform symbol (or bit) sifting using the received first set of symbols at the first device and the fourth set of symbols generated at the second device form determining a common set of sifted symbols from which a cryptographic key may be derived by the first and second devices. The cryptographic key is only known to the first and second devices, thus, they can perform cryptographic operations with each other. The first and second devices then determine a cryptographic key in a quantum-safe manner even when the intermediary device is not a trusted device.

Combining the set of symbols of the first secret symbol string with the set of symbols of the second symbol string may be performed using, without limitation, for example: exclusive or (XOR) operations on the sets of symbols of the first and second symbol strings (e.g. converting the symbol strings into bit strings and performing bitwise XOR); extended XOR operations on the sets of symbols of the first and second symbol strings (e.g. using a mathematically defined extended set of “symbol XOR” operations on symbols that preserve the mathematical properties of bitwise XOR operations); one-time-pad encryption of the set of symbols of the first secret symbols using the set of symbols of the second secret symbols; any other encryption operation on the set of symbols of the first symbol string such that the second device is able to decrypt and retrieve set of symbols of the first symbol string using the set of symbols of the second symbol string received by the second device.

A quantum communication channel(s) may comprise or represent a communication channel capable of transmitting and/or receiving at least quantum information. Examples of a quantum communication channel or quantum channel that may be used according to the invention may include or be based on, without limitation, for example on one or more types of quantum communication channels associated with the group of: optical quantum communications; free-space optical quantum communications; optical fibre quantum communications; optical laser quantum communications; communications using electromagnetic waves such as, without limitation, for example radio, microwave, infra-red, gigahertz, terahertz and/or any other type of electromagnetic wave communications; communications based on electron spin and the like; any other type of quantum communications for transmitting and receiving data over a quantum communication channel between devices. It is noted that one or more types of quantum communication channel(s) may be capable of transmitting and/or receiving non-quantum or classical information.

A standard classical or non-quantum communication channel(s) may comprise or represent any communication channel between two devices that at least is capable of transmitting and/or receiving non-quantum information. Examples of standard, classical and/or non-quantum communication channels according to the invention may include or be based on, without limitation, for example on one or more types of communication channels from the group of: any one or more physical communication channel(s); optical communication channel; free-space optical communication channel; wireless communication channel; wired communication channel; radio communication channel; microwave communication channel; satellite communication channel; terrestrial communication channel; optical fibre communication channel; optical laser communication channel; telecommunications channels; 2G to 6G and beyond telecommunications channels; logical channels such as, without limitation, for example Internet Protocol (IP) channels; any other type of logical channel being provided over any standard, classical or non-quantum physical communication channel; one or more other physical communications or carriers of data such as, without limitation, for example avian carriers, paper, sealed briefcases, courier or other delivery service and the like; any other type of one or more optical, wireless and/or wired communication channel(s) for transmitting data between devices; and/or two or more optical, wireless and/or wired communication channel(s) that form a composite communication channel for transmitting data between devices; and/or any combination of two or more standard, classical or non-quantum communication channel(s) that form a composite communication channel for transmitting and/or carrying data between devices; combinations thereof, modifications thereto, and/or as described herein and the like and/or as the application demands. It is noted that one or more types of standard, classical or non-quantum communication channel(s) may be capable of transmitting and/or receiving quantum information.

The intermediary device may comprise or represent any device or apparatus, component or system that is adapted to, configured to, includes the capability of: establishing a quantum communication channel with one or more other communication devices and/or transmitting data over the quantum communication channel with the one or more other communication devices and, also, establish one of more non-quantum, standard or classical communication channels with said one or more other communication devices for transmitting/receiving data to/from said one or more other communication devices for implementing the QKD protocol according to the invention. Examples of an intermediary device as described herein and/or according to the invention may include, without limitation, for example a satellite or apparatus/components thereof, a ground station or apparatus/components thereof, a relay station, repeater, telecommunication apparatus, network apparatus, network nodes, routers, and/or any apparatus, communication device, computing device or server and the like with a communication interface configured for and/or including functionality of, without limitation, for example a non-quantum, standard or classical communication interface for communicating over non-quantum, standard or classical communication channel(s); and a quantum communication interface for communicating over quantum channel(s).

The first or second communication device (also referred to herein as first or second device) may comprise or represent any device or apparatus with communication components/systems or communication capabilities configured to at least receive data over a quantum communication channel and/or establish one or more non-quantum, standard or classical communication channels with an intermediary device and/or other devices for implementing the QKD protocol according to the invention. Examples of a first or second communication devices according to the invention may include, without limitation, for example a satellite and/or apparatus/components thereof, a satellite ground receiving station and/or apparatus/components thereof, optical ground receiving station, user device, telecommunication apparatus, network apparatus, network nodes, routers, and/or any communication device, computing device or server and the like with a communication interface configured for and/or including functionality of, without limitation, for example a non-quantum, standard or classical communication interface for communicating over non-quantum, standard or classical communication channel(s); and a quantum communication interface for communicating over quantum channel(s).

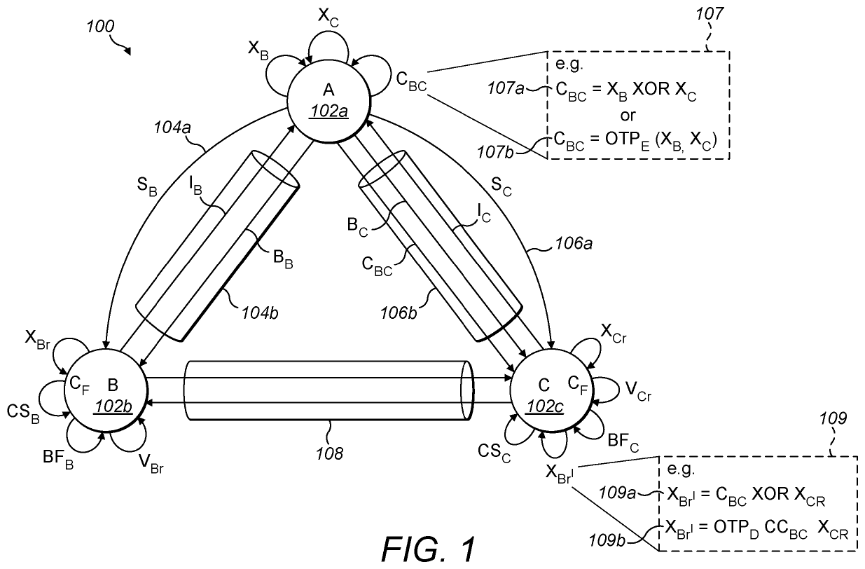

FIG. 1 is a schematic diagram illustrating an example quantum key distribution system 100 that performs a QKD protocol according to the invention. The QKD system 100 includes an intermediary device 102a, a first device 102b and a second device 102c in communication with each other. The first and second devices 102b and 102c may require a shared key that is facilitated by at least the intermediary device 102a. The intermediary device 102a is configured to generate random symbol strings/streams and transmit these to the first and second devices 102b and 102c according to the QKD protocol over first and second quantum communication channels 104a and 106a, respectively. The intermediary device 102a also communicates with the first and second devices 102b and 102c over first and second non-quantum or standard/classical communications channels 104b and 106b, respectively, for exchanging further key and protocol data. Once all the required key and/or protocol data has been exchanged between the intermediary device 102a and the first and second devices 102b and 102c, the first and second devices 102b and 102c communicate with each other over a third non-quantum or standard/classical communications channel 108 to establish a common secret set of symbols from which a common cryptographic key or final cryptographic key (e.g. CF) may be agreed upon and/or derived and the like for use by the first and second devices 102b and 102c in, without limitation, for example cryptographic operations/communications between the first and second device 102b and 102c. The QKD protocol ensures that the final cryptographic key CF can be agreed upon that the intermediary device 102a cannot derive even though it generated the first and second secret symbol strings for each device 102b and 102c.

For simplicity, the intermediary device 102a is referred to as Alice 102a, the first device 102b is referred to as Bob 102b and the second device 102c is referred to as Carol 102c. The implementation of the QKD protocol with respect to Alice 102a, Bob 102b and Carol 102c is described, without limitation, for example in five main protocol parts or portions based on the following: a first protocol part describing a first set of key exchange interactions between Alice 102a and Bob 102b; a second protocol part describes a second set of key exchange interactions between Alice 102a and Carol 102c; a third protocol part describes third set of key exchange interactions between Alice 102a and Carol 102c; a fourth protocol part describes fourth set of key agreement steps by Carol 102c; and a fifth protocol part describes a fifth set of key exchange interactions between Bob 102b and Carol 102c for forming the common/shared key of the QKD protocol between Bob 102b and Carol 102c. The following QKD protocol parts are described, without limitation, for example in relation to Alice 102a, Bob 102b and/or Carol 102c based on the following:

In the first part of the QKD protocol, Alice 102a and Bob 102b perform a first set of key exchange interactions in which Alice 102a and Bob 102b exchange a first secret symbol stream or string (e.g. SB). Each symbol in the first secret symbol stream (e.g. SB) may represent n bit(s), so each symbol may be one of M=2ⁿ different symbols where n≥1. Alice 102a randomly generates the symbols for the first secret symbol stream (e.g. SB), or randomly generates a bit string/stream that is converted into the first secret symbol stream (e.g. SB). Alice 102a sends the first secret symbol string, SB, to Bob 102b over a first quantum channel 104a. For each symbol in SB that is sent to Bob 102b, Alice 102a randomly selects a basis from a set of bases (e.g. B) for modulating said each symbol for transmission over the first quantum channel 104a.

For example, the first quantum channel 104a may be, without limitation, a free-space optical quantum channel or a fibre optical quantum channel between Alice 102a and Bob 102b, where Alice 102a has a quantum optical transmitter and Bob 102b has a quantum optical receiver. The set of bases B includes at least two different bases. Each of the bases includes a set of basis states for representing each of the different M=2ⁿ symbols of the first secret symbol string. Each set of basis states for each basis includes M=2ⁿ different basis states. The basis states for each basis may be orthogonal. The basis states for a first basis may not be orthogonal to one or more basis states of a second basis of the set of bases.

The set of bases B may include two or more bases, without limitation, for example, a rectilinear optical polarisation basis, a diagonal optical polarisation basis, angular optical polarisation basis, and/or any other suitable optical basis for converting the symbols into modulated symbols for transmission over a quantum channel. Although optical quantum channels and corresponding bases for transmitting symbols over said optical quantum channel are described, by way of example only the invention is not so limited, it is to be appreciated by the skilled person that the QKD protocol according to the invention may be used over any type of quantum communication channel between Alice 102a and Bob 102b and/or as the application demands.

Bob 102b demodulates each symbol of the first secret symbol string, SB, received via the first quantum channel 104a by randomly selecting a basis from the set of bases B (e.g. Bob 102b has the same set of bases B as Alice 102a) that is used to demodulate the received symbols from the first quantum channel 104a. Typically, a symbol is successfully received when the output or measurement of the demodulator of Bob 102b clearly indicates data representative of one of the basis states of the selected basis that Bob 102b randomly selected. Thus, a symbol is successfully received when the measurement output of the demodulator indicates a symbol has actually been received in relation to the basis states of the selected basis used. This means that a successfully received symbol output by the demodulator will be either: 1) a symbol that is the same symbol as the transmitted symbol because the selected basis (or basis state) used by the demodulator matches the selected basis (or basis state) used to originally modulate the transmitted symbol; and 2) a symbol that is a different symbol as the transmitted symbol because the selected basis (or basis state) used by the demodulator did not match the selected basis (or basis state) used to originally modulate the transmitted symbol. That is, a successfully received symbol is a symbol output or measurement from the demodulator in which a matching basis or an unmatched basis is used compared with the basis used for modulating and transmitting the symbol. An unsuccessfully received symbol is when the measurement output of the demodulator is below predetermined basis state thresholds indicating no symbol is received in relation to the selected basis used. This means a symbol has not been received at all in relation to the selected basis used. For example, when the measurement of the received symbol is greater than or equal to a basis state threshold corresponding to a basis state of the selected basis, then a symbol has been successfully received. A symbol is not successfully received when the output or measurement of the demodulator of Bob 102b is below or does not reach a basis state threshold corresponding to a basis state of the selected basis. A symbol is valid, when the symbol is successfully received and when the basis (or basis state) used to modulate and transmit the symbol is the same as the basis (or basis state) used to demodulate the transmitted symbol. A symbol is invalid, when the symbol is successfully received and when the basis (or basis state) used to modulate and transmit the symbol is the different to the basis (or basis state) used to demodulate the transmitted symbol.

In particular, if Alice 102a and Bob 102b chose the same basis for modulating a symbol for transmission and demodulating the transmitted symbol, respectively, then quantum physics states that there is a high probability that the basis state of the symbol received by Bob 102b will be the same as the transmitted basis state used for transmitting the symbol by Alice 102a, i.e. is validly and successfully received. The symbol is valid because the basis used by Alice 102a for transmission is the same basis used by Bob 102b when receiving the transmitted symbol. If Alice 102a and Bob 102b chose a different basis for modulating a symbol for transmission and demodulating the transmitted symbol, respectively, then quantum physics states that there is a low probability that the basis state of the symbol received by Bob 102b will be correlated with the transmitted basis state used for transmitting the symbol by Alice 102a, but instead will be a random selection from the possible basis states in that basis, i.e. is successfully received, but invalid because the received/demodulated symbol is different to the original symbol that is transmitted. Given that there may be losses in the quantum channel, including the quantum transmitter and receiver, it is to be expected that some of the symbols transmitted by Alice 102a over the first quantum channel 104a are not successfully received by Bob 102b. Thus, Bob 102b determines the symbol numbers or locations within the first secret symbol string (e.g. SB) that Bob 102b successfully receives.

Bob 102b then sends to Alice 102a over a first classical communication channel 104b an indication of symbols (e.g. I_{B}) including successfully received symbols that includes, without limitation, for example data representative of the symbol numbers (e.g. bit numbers) of the successfully received symbols (e.g. #2, #718, #2818, . . . ) Note, the symbol numbers do not indicate which basis Bob 102b used or which basis states Bob 102b actually assigned to each received symbol or even which symbols were received. Rather, the data representative of symbol numbers or locations are simply an indication that Bob 102b managed to demodulate those corresponding symbols and map them to a basis state. In addition, the indication of symbols I_{B} that Bob 102b sends Alice 102a (i.e. I_{B}) over the first classical channel 104b also includes the locations (or symbol numbers) of one or more symbols that was not successfully received by Bob 102b (these may be referred to as decoy received symbols). For example, along with the successfully received symbols (e.g. with symbol numbers #2, #718, #2818, . . . ), Bob 102b inserts some locations of symbols that were not successfully received by Bob 102b e.g. #2, #718, #801, #910, #2818, #3012 etc., where Bob 102b has inserted numbers #801, #910, and #3012 of symbols that were not successfully received. In one embodiment, the number of decoy received symbols are larger than the number of successfully received symbols. For example, the number of decoy received symbols are an order of magnitude larger than the number of successfully received symbols. Thus, I_{B} can be labeled as the first reported symbols numbers, which includes the data representative of symbol numbers, as well as symbol or location numbers of the decoy received symbols. Note that the phrase “data representative of symbol numbers or locations” above corresponds to the locations of successfully received symbols by Bob 102b, and the phrase “symbol or location numbers” to the locations of the decoy received symbols. Bob 102b records the symbols numbers of the decoy received symbols, which will be required during subsequent processing steps.

For example, when n=1 bit per symbol i.e. a symbol is a bit (e.g. two symbols are used to represent the bits ‘0’ and ‘1’), if Alice 102a sends a first secret bit string or stream of 1,000,000 bits over the first quantum channel 104a, then, when Bob 102b randomly selects the basis from the set of bases B for demodulating the bits of the first secret bit string, Bob 102b may only, without limitation, for example successfully receive around 900 bits due to atmospheric losses and/or other losses of the first quantum channel 104a. So, the first reported symbols values (e.g. I_{B}) sent by Bob 102b will include a set of indicative values of approximately 900 values representing the bit numbers or bit positions of the bits in the first secret bit string that Bob 102b successfully received, and will also include values representing the bit numbers of some of the bits (e.g. for 100 bits) that Bob 102b did not receive successfully (i.e. decoy received bits), such that the total number of values in the set (I_{B}) sent by Bob 102b will be 1000.

Alice 102a may discard all the other symbols (e.g. bits) from the first secret symbol string (e.g. SB) that Bob 102b did not report to Alice 102a. This means that Alice 102a may generate or form a first set of secret symbols (e.g. XB) from the first secret symbol stream (e.g. SB) using the first reported symbol numbers representing the symbols Bob 102b successfully received and the symbol numbers representing the symbols that Bob 102b did not successfully receive (i.e. decoy received symbols). Similarly, Bob 102b may discard all the other unsuccessfully received symbols resulting in a first received set of secret symbols (e.g. XBr), which includes the successfully received symbols as well as decoy received symbols. As mentioned before, Bob 102b has a record of the symbols numbers of all the decoy received symbols. Note that some of the successfully received symbols may still comprise symbols where Bob 102b has used a different basis state to demodulate the symbol than compared to the (unmatched) basis state used by Alice 102c to modulate the same symbol (i.e. not all of them will be validly received symbols).

Alice 102a then sends to Bob 102b over the first classical communication channel 104b a first set of bases or first basis state set (e.g. BB) corresponding to each basis state that Alice 102a used to transmit the the first reported symbols (IB) in its original transmission (e.g. SB) over the first quantum channel 104a to Bob 102b. Bob 102b then compares the basis that Bob 102b used to demodulate each successfully received symbol (from XBr) with the corresponding basis in the received set of bases (e.g. BB) sent by Alice 102a. Thus, Bob 102b may form a first set of basis flags (e.g. BFB) including a plurality of indications/flags corresponding to each symbol of the first received set of secret symbols (e.g. XBr), where each indication/flag for a symbol indicates whether that symbol in the first received set of secret symbols (e.g. XBr) was validly received or not based on the comparison of bases, or if it is a decoy received symbol (e.g. an indication/flag of ‘1’ indicates a validly received symbol, an indication/flag of ‘0’ indicates a symbol not validly received, including symbols belonging to the decoy received symbols). Thus, Bob 102b may also form a first validly received set of secret symbols (e.g. VBr) comprising only those symbols in which Bob 102b used a matching basis during demodulation of the original first secret symbol string (e.g. SB). For example, when n=1, Bob 102b may find that around 500 bits of the 1000 bits comprising the “successfully” received bits and the decoy received bits, were validly received.

In a second part of the QKD protocol, Alice 102a and Carol 102c perform a second set of key exchange data interactions. For example, Alice 102a sends a second secret symbol string (e.g. SC) to Carol 102c over a second quantum channel 106a. For each symbol in the second secret symbol string (e.g. SC) that is sent to Carol 102c, Alice 102a randomly selects a basis from the set of bases B for modulating said each symbol for transmission over the second quantum channel 106a. For example, the second quantum channel 106a may be, without limitation, for example a free-space optical quantum channel between Alice 102a and Carol 102c, where Alice 102a has a quantum optical transmitter and Carol 102c has a quantum optical receiver. Carol 102c demodulates each symbol received via the second quantum channel 106a by randomly selecting a basis from the set of bases B that is used to demodulate the received symbols from the second quantum channel 106a.

Typically, as for Bob 102b, a symbol is successfully received when the output or measurement of the demodulator clearly indicates data representative of one of the basis states of the selected basis that Carol 102c randomly selected. Given that there may be losses in the quantum channel, including the quantum transmitter and receiver, it is to be expected that some of the symbols transmitted by Alice 102a over the second quantum channel 106a are not successfully received by Carol 102c. Thus, Carol 102c determines the symbol numbers or locations within the second secret symbol string (e.g. SC) that are successfully received. These symbol numbers will be different to those sent by Bob 102b. bCarol 102c then sends to Alice 102a over a second classical communication channel, set up between Alice 102a and Carol 102c, an indication of symbols (e.g. I_{C}) including successfully received symbols that includes, without limitation, for example data representative data representative of the symbol numbers (e.g. bit numbers) of the successfully received symbols (e.g. #3, #141, #5926, . . . ) Note, the symbol numbers do not indicate which basis Carol 102c used or which basis states Carol 102c actually assigned to each received symbol or even which actual symbols were received. Rather, the symbol numbers or locations are simply an indication that Carol 102c managed to demodulate those corresponding symbols and map them to a basis state. Additionally, the indication of symbols I_{C} that Carol 102c sends Alice 102a over the second classical channel 106b also includes the locations (or symbol numbers) of one or more symbols that was not successfully received by Carol 103c (decoy received symbols). For example, along with the successfully received symbols (e.g. with symbol numbers #3, #141, #5926 . . . ), Carol 102b inserts some locations of symbols that were not successfully received by Carol 102b e.g. #3, #141, #202, #607 #, #5926, #6001 etc., where Carol 102c has inserted numbers #202, #607, and #6001 of symbols that were not successfully received (i.e. decoy received symbols). In one embodiment, the number of decoy received symbols are larger than the number of successfully received symbols. For example, the number of decoy received symbols are an order of magnitude larger than the number of successfully received symbols. Thus, Ic, can be labelled as the second reported symbols numbers, which include the data representative of the location of successfully received symbols by Carol 102c, as well as symbol numbers of the decoy received symbols. As with Bob 102b, the phrase “data representative of symbol numbers or locations” corresponds to the successfully received symbols by Carol 102c, and the phrase “symbol or location numbers” are to the location of the decoy received symbols. Carol 102c records the symbols numbers of the decoy received symbols, which will be required during subsequent processing steps.

For example, when n=1 bit per symbol (e.g. two symbols are used to represent the bits ‘0’ and ‘1’), if Alice 102a sends a second secret bit string or stream of 1,000,000 bits over the second quantum channel 106a, then in practice, when Carol 102c randomly selects the basis from the set of bases B for demodulating the bits of the second secret bit string, Carol 102c may only, without limitation, for example successfully receive around 900 bits due to atmospheric losses and/or other losses of the second quantum channel 106a. So, the second reported symbols values (e.g. I_{C}) sent by Carol 102b will include a set of indicative values of approximately 900 values representing the bit numbers or bit positions of the bits in the second secret bit string that Carol 102c successfully received, and will also include values representing the bit numbers of some of the bits (e.g. for 100 bits) that Carol 102c did not successfully (i.e. decoy received bits), such that the total number of values in the set (I_{C}) sent by Carol 102c will be 1000.

Alice 102a may discard all the other symbols (e.g. bits) from the first secret symbol string (e.g. SC) that Carol 102c did not report to Alice 102c. This means that Alice 102a may generate or form a second set of secret symbols (e.g. XC) from the second secret symbol stream (e.g. SC) using the second reported symbol numbers in IC representing the symbols Carol 102c successfully received, and symbol numbers representing the symbols that Carol 102c did not successfully receive (i.e. decoy received symbols). Similarly, Carol 102c may discard all the other unsuccessfully received symbols, resulting in a second received set of secret symbols (e.g. XCr) which includes the successfully received symbols as well as decoy received symbols. As mentioned before, Carol 102c has a record of the symbols numbers of all the decoy received symbols. Note that some of the successfully received symbols may still comprise symbols where Carol 102c has used a different basis state to demodulate the symbol than compared to the basis state used by Alice 102c to modulate the same symbol (i.e. not all of them will be validly received symbols).

Alice 102a then sends to Carol 102c over the second classical communication channel 106b a second set of bases or second basis state set (e.g. BC) corresponding to each basis state that Alice 102a used to transmit the second reported symbols (IC) in its original transmission (e.g. SC) over the second quantum channel 106a to Carol 102c. Carol 102c then compares the basis that Carol 102a used to demodulate each successfully received symbol (i.e. for all symbols XCr) with the corresponding basis in the received second set of bases (e.g. BC) sent by Alice 102a. Thus, Carol 102c may form a second set of basis flags (e.g. BFC) including a plurality of indications/flags corresponding to each symbol of the second received set of secret symbols (e.g. XCr), where each indication/flag for a symbol indicates whether that symbol in the second received set of secret symbols (e.g. XCr) was validly received or not based on the comparison of bases, or if it is a decoy received symbol (e.g. an indication/flag of ‘1’ indicates a validly received symbol, an indication/flag of ‘0’ indicates a symbol not validly received, including belonging to the decoy received symbols). The second set of bases BC can be used by Carol 102c to check which symbols of the second received set of secret symbols (e.g. XCr) were validly received. Thus, Carol 102c may also form a second validly received set of secret symbols (e.g. VCr) comprising only those symbols in which Carol 102c used a matching basis during demodulation of the original second secret symbol string (e.g. SC) that Alice 102a used for modulation of those symbols. For example, when n=1, Carol 102c may find that around 500 bits of the 1000 bits comprising the “successfully” received symbols and the decoy received symbols were validly received.

In a third part of the QKD protocol, a third set of key exchange interactions is performed in which Alice 102a sends Carol 102c the first set of secret symbols (e.g. XB). Alice 102a does not know which symbols of the first set of secret symbols (e.g. XB) were validly received by Bob 102b or which are the decoy received symbols. Rather, Alice 102a sends Carol 102c the first set of secret symbols (e.g. XB) using a masking or encryption approach to protect the first set of secret symbols (e.g. XB). In particular, Alice 102a generates a third secret symbol string (e.g. CBC) based on Alice 102a performing a set of processing operations 107 for combining the first set of secret symbols (e.g. XB) with the second set of secret symbols (e.g. XC) using one or more combining operations. The first set of secret symbols (e.g. XB) correspond to those symbols from the first secret symbol string (e.g. S_{B}) that Bob 102b indicated to Alice 102a were received successfully by Bob 102b (e.g. in the above example, when n=1, roughly 1000 bits were received successfully by Bob 102b). The second set of secret symbols (e.g. X_{C}) correspond to those symbols from the second secret symbol string (e.g. X_{C}) that Carol 102c indicated to Alice 102a were received successfully by Carol 102c (e.g. in the above example, when n=1, roughly 1000 bits were received successfully by Carol 102c).

For example, the one or more processing operations 107 performed for combining the first and second sets of secret symbols (e.g. XB and XC) may include, without limitation, for example, one or more processing operations of: when n=1, then symbol strings are bit strings, and the one or more symbol operations include a bitwise XOR operation 107a performed between the first set of secret bits (e.g. XB) and the second set of secret bits (e.g. XC) producing a third secret bit string CBC (e.g. CBC=XB XOR XC); when n>1, the first and second sets of secret symbols (e.g. XB and XC) may be converted to bit strings and the one or more symbol operations may include a bitwise XOR operation performed between the first set of secret bits (e.g. XBb) and the second set of secret bits (e.g. XCb), resulting in a third secret bit string (e.g. CBCb=XBb XOR XCb), which may be re-converted into the third secret symbol string (e.g. CBC); an extended XOR operation, with equivalent properties as a bitwise XOR, may be performed directly on the corresponding symbols of the first and second sets of secret symbols (e.g. CBC=XB XOR XC); one-time-pad (OTP) encryption operations 107b on the first set of secret symbols (e.g. XB) using the second set of secret symbols (e.g. XC) as the OTP, or using an OTP or key that was previously exchanged with Carol 102c (e.g. CBC=OTPE(XB, XC)); and/or any other masking or obfuscation operation using the first and second sets of secret symbols (e.g. XB and XC) for producing a third secret symbol string (e.g. CBC), from which Carol 102c may derive a received first set of secret symbols (e.g. XBr′) using Carol's 102c received set of secret symbols (e.g. XCr). Alice 102a sends the third secret symbol string (e.g. CBC) to Carol 102c over the second classical communication channel 106b.

In some examples, the protocol may be implemented in such a way that length (or the number) of symbols in Xb and Xc are equal. This is achieved by Bob 102b and Carol 102c inserting a different number of decoy received symbols to XB and XC, respectively, based on the successfully received symbols received by Bob 102b and Carol 102c, such that the resulting length of XB and XC is the same.

For the above example, when n=1 and the first set of bits and the second set of bits each equals 1000 bits, Alice 102a performs a bitwise XOR between the first set of bits (e.g. bits successfully received by Bob 102b and the decoy received bits) and the second set of bits (e.g. bits successfully received by Carol 102c and the decoy received bits) producing a third secret bit string (e.g. CBC). Thus, the third secret bit string (e.g. CBC) will encapsulate those bits that both Bob 102b and Carol 102c successfully received, as well as their decoy received bits. Alice 102a sends the third secret bit string (e.g. CBC) to Carol 102c via the second classical communication channel 106b.

In a fourth part of the QKD protocol, a fourth set of key agreement steps is performed by Carol 102c. Once Alice 102a sends Carol 102c the third secret symbol string (e.g. CBC), Carol 102c performs a set of corresponding processing operations 109 for generating a fourth set of secret symbols (e.g. XBr′) using the received second set of secret symbols (e.g. XCr), which Carol 102c successfully received, and the received third secret symbol string (e.g. CBC). The fourth set of secret symbols (e.g. XBr′) includes symbols from the first secret set of symbols (e.g. XBr). For example, if Alice 102a performed an XOR operation 107a using the first and second sets of secret symbols (e.g. XB and XC) to produce the third set of secret symbols (e.g. CBC), then Carol 102c can perform an XOR operation(s) 109a for generating a fourth set of secret symbols (e.g. XBr′), where the XOR operation(s) 109a operates using the received third secret symbol string (e.g. CBC) and the received second set of symbols (e.g. XCr), i.e. the fourth set of secret symbols XBr′=CBC XOR XCr. For example, when n=1, the symbol strings are bit strings and Alice 102a uses the bitwise XOR operation 107a to generate a third secret bit string (e.g. CBC=XB XOR XC) using the first set of symbols (e.g. XB) and second set of symbols (e.g. XC). Carol 102c, on receiving the third secret symbol string (e.g. CBC), performs a bitwise XOR operation 109a using the received third secret symbol string (e.g. CBC) and the received set of secret symbols (e.g. XCr) to generate a fourth secret symbol string (e.g. XBr′=CBC XOR XCr), which comprises symbols from the first secret symbol string (e.g. XB). For example, XBr′=(XB XOR XC)XOR XCr=(XB XOR(XC XORXCr)=XB, when no errors occur in the successful symbols that Carol 102c receives. Thus, due to XOR operation 107 (FIG. 1) encapsulating Bob's 102b symbols via XB, XBr′ will comprise symbols which are common to both Bob 102b and Carol 102c. Thus, the next stage of this process is to identify the symbols numbers of the symbols that comprise XBr′ (and VBr) that are common to both Carol 102c and Bob 102b to derive an encryption key. If there are errors in the successful symbols that Carol 102c receives, then only those symbol positions of the symbols that Carol 102c validly receives (e.g. VCr) in XBr′ will correspond to the same symbol positions in XB. Alternatively, the fourth symbol string XBr′ could be generated using Carol 102c the second validly received set of secret symbols, VCr, instead of XCr i.e. XBr′=CBC XOR VCr.

Note that in general CBC and XCr or VCr may be of different lengths, since CBC corresponds to those symbol which Bob 102b and Carol 102c have successfully received as well as decoy received symbols, while XCr comprises only the successfully received symbols by Carol 102c, and VCr the validly received symbols. Therefore, to perform a successful bitwise XOR operation between CBC and XCr or VCr, Carol 102c must either: i) discard part of CBC to make the length of CBC equal to XCr or VCr, ii) pad XCr or VCr with decoy received symbols declared by Carol 102c to make the length of CBC equal to XC, iii) consume more CBC material in comparison to XCr or VCr material (retaining any unused bits from the longer string for later use), or iv) break CBC and XCr or VCr into equal length blocks before performing the bitwise XOR operation.

In another example, when n>1, Alice 102a may have converted the first and second sets of secret symbol strings into bit strings in which a bitwise XOR operation is performed between the first set of secret bit strings and the second set of secret bit string, resulting in a third secret bit string, which may be re-converted into the third secret symbol string. Thus, Carol 102c may perform a similar set of operations, by converting the received third secret symbol string into a received third secret bit string and perform a bitwise XOR operation using the received third secret bit string and the received second set of secret bits (converted from the received second set of secret symbols) to generate a fourth secret bit string, which is converted to a fourth secret symbol string. Alternatively, Alice 102a may use one or more extended XOR operations performed on the corresponding symbols of the first and second sets of secret symbols to generate the third secret symbol string. Carol 102c, may then perform similar one or more extended XOR operations using the received third secret symbol string and the received second set of secret symbols to generate the fourth symbol string. Alternatively or additionally, Alice 102a may have used OTP encryption operations 107b on the first set of symbols (e.g. XB) using the second set of symbols (e.g. XC) (or an OTP exchanged with Carol 102c) to generate the third secret symbol string (e.g. CBC=OTPE(XB, XC)), in which Carol 102c performs OTP decryption operations 109b on the received third secret symbol string (e.g. CBC) using the received second set of symbols (e.g. XCr) (or an OTP exchanged with Alice 102a) to generate the fourth secret symbol string (e.g. XBr′=OTPD(CBC, XCr)). Simply put, Carol 102c performs the required symbol operations required to generate a fourth secret symbol string (e.g. XBr′) from the received third secret symbol string (e.g. CBC) using, without limitation, for example the received second set of secret symbols (e.g. XCr or VCr.), where the fourth secret symbol string (e.g. XBr′) includes one or more symbols of the first secret symbol string (e.g. SB) or first set of secret symbols (e.g. XB).

It is noted that the received second set of secret symbols (e.g. XCr) includes only those symbols that Carol 102c considered were received successfully, but which have not been checked as valid. Thus, using an XOR or some of the above operations, some of the symbols in the received second set of secret symbols (e.g. XCr) may be invalid because Carol 102c may have used a different basis compared with the basis that Alice 102a used to transmit these symbols. Additionally, as mentioned above, the third secret bit string (e.g. CBC) will encapsulate those symbols that both Bob 102b and Carol 102c successfully received, and also their decoy received symbols. This means that the corresponding symbols of the fourth secret symbol string (e.g. XBr′) may be invalid, and also include some symbols that correspond to symbol numbers of the decoy received symbols of Bob 102b. However, there will be a portion of symbols in the fourth secret symbol string (e.g. XBr′) that are valid, which have positions in XBr′ that correspond to the positions of the valid symbols in the received second set of secret symbols (e.g. XCr) i.e. the valid received second set of symbols (e.g. VCr). The valid symbols of XBr′ will be the same as the corresponding symbols of the first set of secret symbols XB. The valid symbols of the fourth secret symbol string (e.g. XBr′) correspond to the valid second received set of secret symbols that Carol 102c checked with the received set of bases BC from Alice.

In a fifth part of the QKD protocol, a fifth set of key exchange interactions between Carol 102c and Bob 102b are performed. In particular, Carol 102c and Bob 102b perform symbol sifting (or bit sifting) or key exchange operations with each other using a third communication channel 108 in which Alice 102a is not a party to. For example, during the first part of the QKD protocol, Bob 102b used the received first set of bases BB from Alice 102a and the set of bases Bob 102b used when receiving the symbols in the received first set of secret symbols (e.g. XBr) to determine a first set of basis flags (e.g. BFB) (or list of matching bases). That is, Bob 102b formed a first set of basis flags (e.g. BFB) including a plurality of indications/flags corresponding to each symbol of the first received set of secret symbols (e.g. XBr), where each indication/flag for a symbol indicates whether that symbol in the first received set of secret symbols (e.g. XBr) was validly received or not based on the comparison of bases, or to a decoy received symbol (e.g. an indication/flag of ‘1’ indicates a validly received symbol, an indication/flag of ‘0’ indicates a symbol not validly received or decoy received symbol).

Similarly, Carol 102c also used the received second set of bases BC from Alice 102a and the set of bases Carol 102c used when receiving the second symbol string to determine a second set of basis flags (e.g. BFC) (or list of matching bases) indicating whether each symbol in the received second set of secret symbols (e.g. XCr) was validly or not validly received, or if it is a decoy received symbol. That is, Carol 102c formed a second set of basis flags (e.g. BFC) including a plurality of indications/flags corresponding to each symbol of the second received set of secret symbols (e.g. XCr), where each indication/flag for a symbol indicates whether that symbol in the second received set of secret symbols (e.g. XCr) was validly received or not based on the comparison of bases, or to a decoy received symbol (e.g. an indication/flag of ‘1’ indicates a validly received symbol, an indication/flag of ‘0’ indicates a symbol not validly received or decoy received symbols).

Bob 102b sends the first set of basis flags (e.g. BFB) (e.g. first set of matching bases) to Carol 102c and Carol 102c sends the second set of basis flags (e.g. BFC) to Bob 102b over the third communication channel 108. For example, in the above example, when n=1, and if Bob 102b received 1000 bits (some of which are successfully received and are valid or invalid, and some of which are decoy received bits), then the first set of basis flags (e.g. BFB) includes 1000 indications/flags corresponding to the 1000 bits, each indication/flag representing whether the corresponding bit was validly received or not, or was a decoy received bit. Similarly, if Carol 102c received 1000 bits (some of which are successfully received and are valid or invalid, and some of which are decoy received bits), then the first set of basis flags (e.g. BFC) includes 1000 indications/flags corresponding to the 1000 bits, each indication/flag representing whether the corresponding bit was validly received or not, or was a decoy received bit.

On receiving the second set of basis flags (e.g. BFC) from Carol 102c, Bob 102b forms a first common set of secret symbols (e.g. CSB) by comparing each basis flag in the first set of basis flags (e.g. BFB) with each basis flag in the received second set of basis flags from Carol 102c (e.g. BFC) and discards those symbols from the valid first received set of secret symbols (e.g. VBr) where the corresponding basis flags from the first and received second sets of basis flags (e.g. BFB and BFC) do not match. The undiscarded or remaining symbols of the valid first received set of secret symbols (e.g. VBr) forms the first common set of secret symbols (e.g. CSB) for Bob 102b, which is equivalent to the final cryptographic key CF. Similarly, receiving the first set of basis flags (e.g. BFB) from Bob 102b, Carol 102c forms a second common set of secret symbols (e.g. CSC) by comparing each basis flag in the received first set of basis flags (e.g. BFB) with each basis flag in the second set of basis flags (e.g. BFC) and discards those symbols from the fourth secret symbol string (e.g. XBr′) where the corresponding basis flags from the received first set of basis flags (e.g. BFB) and second set of basis flags (e.g. BFC) do not match. The remaining symbols in the fourth secret symbol string (e.g. XBr′) forms the second common set of secret symbols (e.g. CSC) for Carol 102c. Due to the XOR operations 107 and 109, the second common set of secret symbols (e.g. CSC) will be identical to the first common set of secret symbols (e.g. CSB). Thus, Carol 102c will be able to use the second common set of secret symbols (e.g. CSC) as the final cryptographic key CF, which will be identical to the key Bob 102b has obtained.

Bob 102b and Carol 102c now have a common set of secret symbols (e.g. CSB and CSC), Bob has a first common set of secret symbols (e.g. CSB) and Carol has a second common set of secret symbols (e.g. CSC). Although the first common set of secret symbols (e.g. CSB) may be the same as the second common set of secret symbols (e.g. CSC), they may not necessarily be the same due to errors from transmission or measurement during demodulation and the like. Thus, Bob 102b and Carol 102c may perform error detection and/or correction in relation to the first and second common sets of secret symbols (e.g. CSB and CSC) over the third communication channel 108. For example, the error detection and correction of the first and second common sets of secret symbols (e.g. CSB and CSC) that takes place between Bob 102b and Carol 102c may be based on, without limitation, for example how error detection and correction of the first and second common sets of secret symbols is implemented or performed using the standard Decoy State Protocol or the Standard BB84 Protocol and the like. However, in those cases Alice 102a knows the cryptographic key and the error detection and correction are made between Alice and Bob and Alice and Carol rather than by Bob and Carol as in the QKD protocol according to the present invention. Nevertheless, these types of error detection and correction can be adapted for use by Bob 102b and Carol 102c for performing error detection and correction of the first and second common sets of secret symbols (e.g. CSB and CSC) and result in a common set of secret symbols from which a cryptographic key, e.g. a final cryptographic key CF, may be produced for Bob 102a and Carol 102c. From this, a final cryptographic key CF may be derived by the Bob 102b and Carol 102c that is only known to the Bob 102b and Carol 102c, thus, they can perform cryptographic operations with each other using a quantum-safe cryptographic key (e.g. CF). The QKD protocol according to the invention enables Bob 102b and Carol 102c to determine a cryptographic key in a quantum-safe manner even when Alice 102a is not a trusted device.

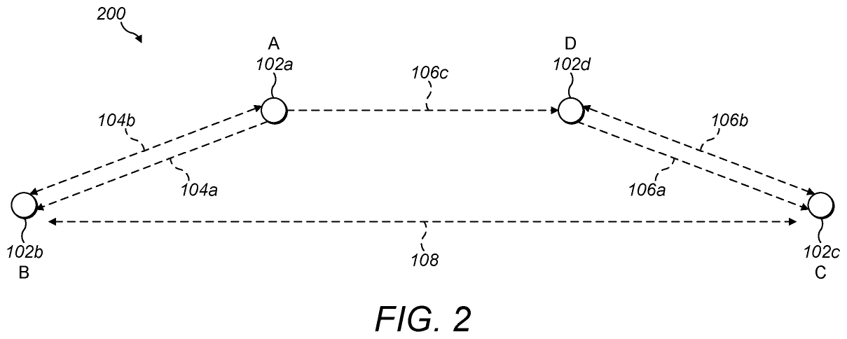

Furthermore, by introducing errors in the symbol locations, the present invention further reduces the amount of information available to Alice 102a. By introducing sufficient number of errors (i.e., by sending a sufficient number of decoy symbols), the information with Alice 102a could be made meaningless. This means that information with Alice 102a could be transmitted to a cascading node, for example, to Dave 102d, who is connected to Carol 102c, as shown in the system 200 of FIG. 2. Dave 102d and Carol 102c could have the quantum 106a and classical 106b communication links to share the raw symbols of Bob 102b (received from Alice 102a to Dave 102d) with Carol 102c. Alice 102a and Dave 102d only require a classical communication link 106c to share the erroneous (meaningless) raw symbols.

In general, the intermediary device 102a comprises one or more nodes. Each node configured to receive data from an adjacent node and/or the first or the second device, and transmit data to an adjacent node and/or the first or the second device. In an exemplary embodiment, a first node (e.g. 102a) that transmits the first secret symbol string SB and the first basis state set BB to the first device 102b, and receives the first reported symbol numbers I_{B} and the third basis set B_{B1} transmitted from the first device 102b. A second node (e.g. 102d) that transmits the second secret symbol string S_{C}, the second basis state set BC, and the secret third symbol string CBC to the second device 102c, receives the second reported symbol numbers IC and the fourth basis set B_{C1} transmitted from the second device 102c, and generates the third secret symbol string CBC. The first node transmits the first set of secret symbols XB, or the first symbol string and the third basis set B_{B1}, to the second node.

In some examples where the intermediary device 102a comprises multiple (i.e., more than one) nodes, the different nodes may be arranged to connect to one another using time-division multiplexing, at least in part. In such examples, one node can be used to connect to two or more other nodes at different times using time-division multiplexing. In some examples, the time-division multiplexing connection may be used in a satellite based implementation, where a node located on a satellite could connect to other nodes at different times as the satellite moves into communication range of respective ones of the other nodes. In other examples, time-division multiplexing could be used in non-satellite based implementations. For example, time-division multiplexing could be used in a switched fibre network based implementation.

In the ARQ19 protocol, when n=1, so that each symbol is one bit, the valid first received set of symbols for Bob 102b may be, without limitation, for example around 500 symbols. Thus, on average approximately half these symbols may have matching basis flags between Bob 102b and Carol 102c, such that the first common secret symbol string is approximately 250 symbols. In ARQ19-DRP, by introducing errors in the location of the symbols, there is a further reduction in the available raw key symbols for error correction and privacy amplification. Assuming a random distribution of decoy symbols within actual symbols, the impact on the final raw symbols will be proportionate to the ratio of successfully received photons and total reported photons, where total reported photons include both the successfully received and decoy received photons reported to Alice 102a. For example, assuming a 1:1 ratio of decoy received compared to the successfully received symbols by both Bob 102b and Carol 102c, there is a 50% reduction the available raw symbols compare to ARQ19 i.e., P/8 symbols are available for error correction and privacy amplification for Bob 102b and Carol 102c. The proportion of decoy received symbols could be configurable for each end independently. For example, only either one of Bob 102b or Carol 102c uses the decoy receive symbol locations or they both use it at different times or different section of raw symbols.

To overcome the reduction of raw symbols, an extension of the above protocol called ARQ19-DRPE (ARQ19-Decoy Receiver Protocol Extension) is proposed, which provides a gain in raw key rate by introducing some additional steps in the protocol. This extension provides a gain in raw key rates available for error correction and privacy amplification. The extension protocol would allow a theoretical key rate equivalent to the standard BB84i.e. P/2 available raw symbols for P received photons by both Bob 102b and Carol 102C. Thus, the extension overcomes the reduction in raw symbols due to both ARQ19 and ARQ19-DRP. ARQ19-DRPE would require Bob 102b and Carol 102c to perform some operations in a symmetric fashion for which some shared symmetric keys would be required (like ARQ19, to encrypt the classical channel between Bob 102b and Carol 102C). The symmetric operation is performed locally by Bob 102b and Carol 102C using a shared symmetric key, and as a result both Bob 102b and Carol 102C know the indices of the matched symbols without the need to share that information over the encrypted classical channel like in ARQ19. This allows both Bob 102b and Carol 102c to retain many more of the validly received symbols than compared to ARQ19-DRP, such that subsequently a greater number of symbols are available to both for forming a quantum key.

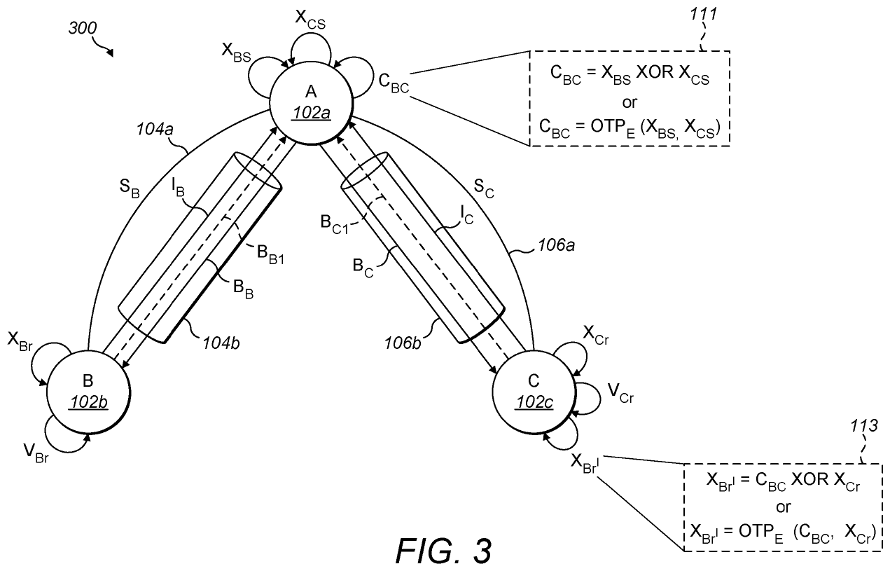

The initial steps of the ARQ19-DRPE are identical to ARQ19-DRP. Referring to system 300 shown in FIG. 3, Alice 102a and Bob 102b perform a first set of key exchange interactions in which Alice 102a and Bob 102b exchange a first secret symbol stream or string (e.g. S_{B}). Alice 102a randomly generates the symbols for the first secret symbol stream (e.g. S_{B}), or randomly generates a symbol string/stream that is converted into the first secret symbol stream (e.g. S_{B}). Alice 102a sends the first secret symbol string, S_{B}, (e.g. 1,000,000 symbols, when n=1) to Bob 102b over a first quantum channel 104a. For each symbol in S_{B} that is sent to Bob 102b, Alice 102a randomly selects a basis from a set of bases (e.g. B) for modulating said each symbol for transmission over the first quantum channel 104a. Bob 102b demodulates each symbol of the first secret symbol string, S_{B}, received via the first quantum channel 104a by randomly selecting a basis from the set of bases B that is used to demodulate the received symbols from the first quantum channel 104a.

Bob 102b then sends to Alice 102a over the first classical communication channel 104b the reported symbol numbers I_{B}, which includes the data representative of symbol numbers (i.e. symbol numbers corresponding to successfully received symbols), as well as symbol or location numbers of the decoy received symbols. Alice 102a then sends to Bob 102b over the first classical communication channel 104b the first set of bases or first basis state set (e.g. B_{B}) corresponding to the reported symbol numbers I_{B}. Bob 102b then forms a first received set of secret symbols XBr, which comprises the validly received symbols, and decoy received symbols and/or successfully received symbols demodulated with a basis state different to Alice 102a.

All of the above steps are also repeated between Alice 102a and Carol 102c. In particular, Carol 102c sends to Alice 102a over the second classical communication channel 106b the reported symbol numbers IC, which includes the data representative of symbol numbers, as well as symbol or location numbers of the decoy received symbols. Alice 102a then sends to Carol 102c over the second classical communication channel 106b the second set of bases or second basis state set (e.g. B_{C}) corresponding to the reported symbol numbers IC. Carol 102c then forms a second received set of secret symbols XCr, which comprises the validly received symbols, and decoy received symbols and/or successfully received symbols demodulated with a basis state different to Alice 102a.

The following steps differentiate ARQ19-DRPE from the ARQ19 protocol. Both Bob 102b and Carol 102c then calculate common symbol positions to be used for positioning validly received symbols within the bases state sets reported by Alice 102a. In another words, by using the symmetric key to generate common symbol positions and position the validly received symbols at these calculated positions, both Bob 102b and Carol 102c will determine a common sequence of positions for the validly received symbols. This means that the common symbol positions are known only to Bob 102b and Carol 102c, and no information about them is provided to Alice 102a. Additionally, both Bob 102b and Carol 102c know their own validly received symbol, and form the first and the second validly received set of secret symbols, VBr and VCr, respectively.

To perform such symmetric positioning, Bob 102b and Carol 102c would require some initial shared entropy. The initial entropy symbols could be manually provisioned and then continuously updated using a small portion of final agreed key symbols between Bob 102b and Carol 102c after post-processing steps. The process could also start without any shared key between Bob 102b and Carol 102c and use standard ARQ19 to agree some shared keys at the start. Subsequently a portion of those keys could be used for starting ARQ19-DRPE protocol to improve on the subsequent key rates.

Bob 102b then sends over to Alice 102a over the first classical communication channel 104b a third set of bases or third basis state set (B_{B1}). The third bases set comprises basis states that were used by Bob 102b to demodulate each validly received symbol of the first secret symbol string, S_{B} (and where the corresponding symbols number are determined using a symmetric key as described above). Additionally, set B_{B1} also comprises one or more basis states from B_{B} for symbols that were not successfully received by Bob 102b and/or one or more basis states from B_{B} used by Bob 102b to demodulate successfully received symbols, but which do not match the basis state (i.e. Invalidly received symbols) used by Alice 102a to modulate the same symbols (i.e. B_{B1} has one or more erroneous basis states).

Similarly, Carol 102c also sends over to Alice 102a over the second classical communication channel 104b a fourth set of bases or fourth basis state set (B_{C1}). As with Bob 102b, the fourth bases set comprises basis states from B_{C} that were used by Carol 102c to demodulate each validly received symbol of the second secret symbol string, S_{C} (and where the corresponding symbols number are determined using a symmetric key as described above). Additionally, bases set B_{C1} also comprises one or more basis states from B_{C} for symbols that were not successfully received by Carol 102c and/or one or more basis states from B_{C} used by Carol 102c to demodulate a successfully received symbol, but which does not match the basis states (i.e. Invalidly received symbols) used by Alice 102a to modulate the same symbols (i.e. B_{C1} has one or more erroneous basis states).

Note that the total length of the B_{B1} and B_{C1} will be equal. This is because both Bob 102b and Carol 102c know exactly how many successfully received symbols they have, and so are able to calculate exactly how many of the other basis states (corresponding to the unsuccessfully received symbols and/or invalidly received symbols) they need in order to have a fixed length of B_{B1} and B_{C1}. Additionally, by sending both the reported symbol numbers IB or Ic as well as the basis state sets B_{B1} or B_{C1} (for Bob 102a and Carol 102c, respectively) to Alice 102a, it increases the uncertainly and makes it more difficult for Alice 102c to derive the final secret key.

As a result of introducing erroneous basis states introduced in both B_{B1} and B_{C1}, Alice 102a still lacks the information about the symbol locations of successfully received symbols and basis states used to demodulate successfully received symbols by Bob 102b and Carol 102c.

Next, using the basis information (B_{B1}) received from Bob 102b, Alice 102a generates a first set of secret symbols (e.g. XB1) from the first secret symbol stream (e.g. SB). Similarly, using information received from Carol 102c (B_{C1}), Alice 102a generates a second set of secret symbols (e.g. XC1) from the second secret symbol stream (e.g. SC). Thus, both the first (XB1) and the second (XC1) set of secret symbols possess symbols numbers that match, respectively, the symbol numbers of the basis states in the third (B_{B1}) and the fourth (B_{C1}) basis state sets.

Alice 102a then performs a shifting operation on both the first (XB1) and the second (XC1) secret symbols to create a first and a second set of shifted secret symbols XBS and XCS, respectively. For example, if XB1 comprises symbols with symbol numbers #1, #122, #304, #1002, #2034 etc, then the shifting operation shifts these symbol numbers such that the symbol numbers for the symbols in XBS are now #0, #1, #2, #3, #4 etc. . . . .

Alice 102a then generates a third secret symbol string (e.g. CBC) based on performing a set of processing operations 111 for combining the first set of shifted secret symbols (e.g. XBS) with the second set of secret shifted symbols (e.g. XCS) using one or more combining operations (e.g. an XOR operation, see previous paragraphs for more details). Alice 102a sends the third secret symbol string (e.g. CBC) to Carol 102c over the second classical communication channel 106b.

Once Alice 102a sends Carol 102c the third secret symbol string (e.g. C_{BC}), Carol 102c performs a set of corresponding processing operations 113 (e.g. XOR operation) for generating a fourth set of secret symbols (e.g. X_{Br′}) using the third secret symbol string (e.g. C_{BC}) and the second received set of secret symbols X_{Cr} or the valid received set of secret symbols V_{Cr} to infer symbols corresponding to the third basis set. Since Bob 102b and Carol 102c know each other's validly received symbol numbers (via the use of the symmetric key), Bob 102b and Carol 102c can discard all other symbols corresponding to the third and the fourth basis sets, respectively, to obtain symbol numbers that are identical to both. Finally, Bob 102b and Carol 102c perform final information reconciliation, error correction and privacy amplification as in standard BB84, resulting in a final shared symmetric key without errors and guaranteed only to be known to them.

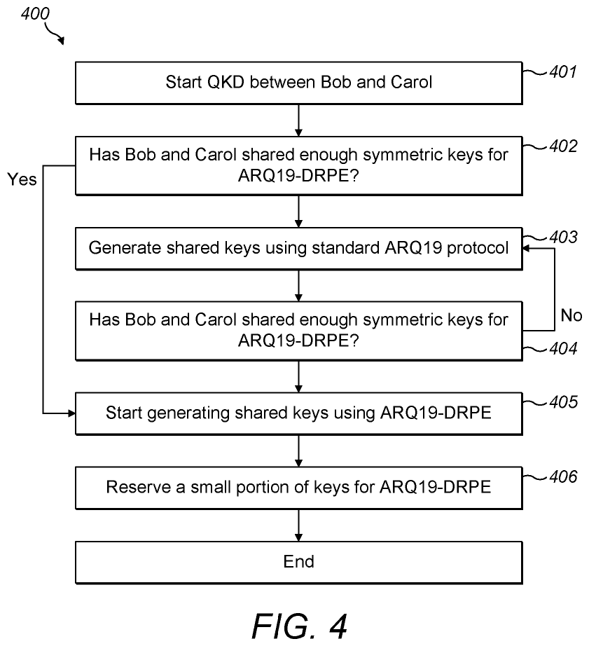

FIG. 4 shows a flowchart 400 illustrating an example of a process for generating keys for the symmetric positioning of symbols. At step 401, a QKD process is initiated between Bob 102b and Carol 102c to generate the symmetry keys for ARQ19-DRPE. At step 402, a check is made to see if there are enough symmetric keys shared between Bob 102b and Carol 102c for generating further keys using ARQ19-DRPE. If so, then at step 405 further keys are generated using ARQ19-DRPE. If not, then at step 403, shared keys are generated using the standard ARQ19 protocol. At step 404, a further check is made to see if there are enough symmetric keys generated for ARQ19-DRPE. If not, the steps 403 and 404 are repeated until there are enough symmetric keys generated for ARQ19-DRPE to be used to generate further keys. Finally, at step 406, a small portion of the keys are reserved for the symmetric positioning of the matches bases within ARQ19-DRPE, as described above.

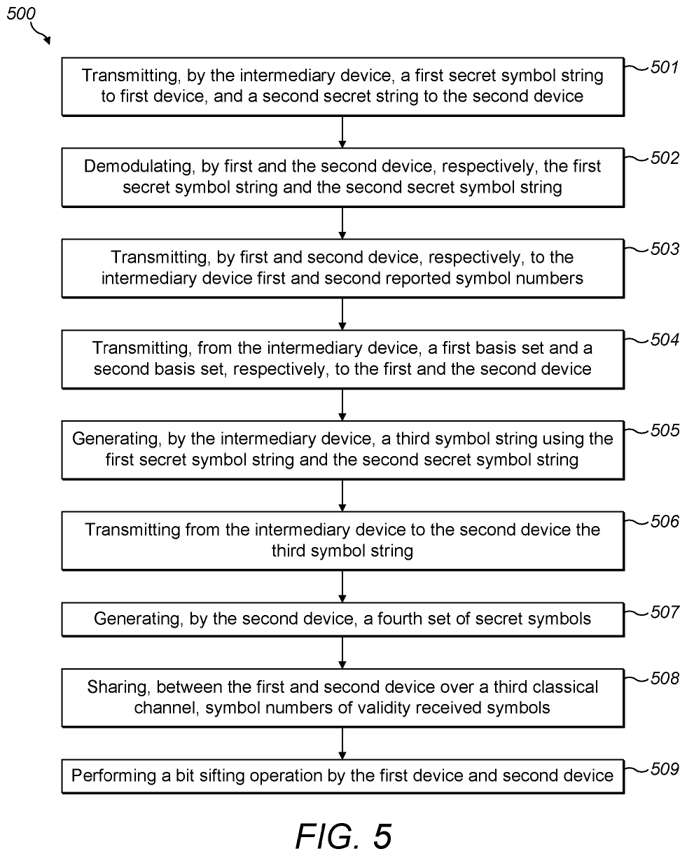

FIG. 5 is flowchart 500 illustrating an example QKD process according to the present invention that is being performed by an intermediary device, a first device and a second device, and in which the first device and second device acquire a shared key according to the ARQ19-DRP protocol. At step 501, the intermediary device transmits a first and a second set of a first secret symbol string to first device over the first quantum channel, and a second secret symbol string to the second device over the second quantum channel. The intermediary device randomly generates the symbols for the first and the second set of secret symbol streams. The intermediary device uses a randomly selected basis state from a set of bases for modulating said each symbol for transmission over the first and the second quantum channels.

At step 502, the first and the second device, respectively, demodulate each symbol in the first secret symbol string and the second symbol string, using a randomly selected basis state from a set of bases. At step 503, the first device and the second device each transmit (via the first and second classical communication channels) respectively, to the intermediary device, first and second reported symbol numbers. The first or second reported symbol numbers correspond to the successfully received symbols, as one or more decoy received symbols.

At step 504, the intermediary device transmits a first basis state set over the first classical communication channel to the first device, and a second basis state set over the second classical communication channel to the second device. The symbol numbers of the basis states in the first and the second basis sets correspond to the reported symbol numbers transmitted by the first and the second device, respectively, to the intermediary device at step 503. Using the basis sets, the first and the second device can obtain, respectively, the first and the second validly received set of secret symbols.

At step 505, the intermediary device generates a third symbol string using the first and the second secret symbol string. To generate the third symbol string, the intermediary device initially generates a first set of secret symbols using the first secret symbol string, and a second set of secret symbols using the second secret symbol string. The first and the second set of secret symbols are generated based on the reported symbol numbers transmitted by the first and the second device to the intermediary device at step 503. The intermediary device then performs a specific operation (e.g. an XOR operation) using the first and the second set of secret symbols to generate the third symbol string.

At step 506, the intermediary device transmits the third symbol string over the second classical communication channel to the second device.

The first and the second device now perform a series of quantum key exchange to obtain symbols that are common to both. In particular, at step 507 the second device generates a fourth set of secret symbols using the third symbol string and the symbols corresponding to the second reported symbol numbers or the second validly received set of secret symbols. More specifically, the fourth set of secret symbols are generated based on performing a specific operation (e.g. an XOR operation) of the third symbol string and the symbols corresponding to the second reported symbol numbers or the second validly received set of secret symbols. From this, the second device is able to infer the symbols corresponding to the first reported symbol numbers of the first device.

At step 508, the first and the second device share, over a third classical communication channel, the symbol numbers of the first validly received set of secret symbols and the second validly received set of secret symbols. Finally, at step 509, the first device and the second device perform symbol shifting operations to identify symbols from the first and the second validly received set of secret symbols with common symbol numbers. As a result of sharing (step 508) the symbol numbers, the second device is able to infer first device's validly received symbols to generate symbols that are identical to both the first and the second device.

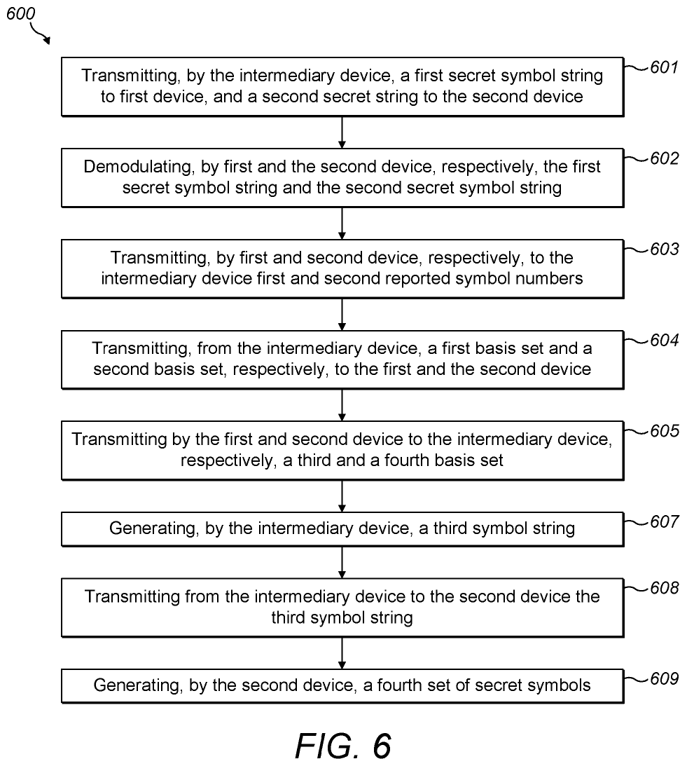

FIG. 6 is flowchart 600 illustrating an example QKD process according to the present invention that is being performed by an intermediary device, a first device and a second device, and in which the first device and second device acquire a shared key according to the ARQ19-DRPE protocol. Steps 601 to 604 of this protocol are identical to ARQ19-DRP. At step 604, the intermediary device transmits the first and the second basis sets, respectively, to the first and the second device. The first and second devices, respectively, are then able to obtain the first and the second validly received set of secret symbols. In contrast to ARQ19-DRP, the first and the second device use a symmetric key to generate a common set of symbols numbers and use them to determine the symbol numbers or locations of, or in other words, to position, their validly received set of secret symbols (step not shown).

Subsequently, at step 605, the first device transmits to the intermediary device a third basis state set over the first classical communication channel, and the second device transmits to the intermediary device a fourth basis state set over the second classical communication channel. The third and the fourth basis states, respectively, comprise basis states used to modulate the validly received symbols of the first and the second secret symbol string, and one or more basis states corresponding to symbols from the first and the second secret symbol string that were successfully received, but not validly received, and/or one or more basis states corresponding to symbols from the first and the second secret symbol string that were not successfully received (i.e. erroneous basis states).

At step 606, the intermediary device generates a third symbol string using the first and the second secret symbol string. To generate the third symbol string, the intermediary device initially generates a first set of secret symbols using the first secret symbol string, and a second set of secret symbols using the second secret symbol string. In contrast to ARQ19-DRP, however, the first and the second set of secret symbols are generated based on the third and the fourth basis sets, respectively (instead of the reported symbol numbers transmitted by the first and the second device to the intermediary device at step 603). The intermediary device then performs a shifting operation of the first set of secret symbols and the second set of secret symbols to produce, respectively, a first and a second set of shifted secret symbols. Finally to obtain the third symbol string, the intermediary device then performs a specific operation (e.g. an XOR operation) using the first and the second set of shifted secret symbols.

At step 607, the intermediary device transmits the third symbol string over the second classical communication channel to the second device. Finally, at step 609 the second device generates a fourth set of secret symbols using the third symbol string and the symbols corresponding to the fourth basis or the second validly received set of secret symbols. More specifically, the fourth set of secret symbols are generated based on performing a specific operation (e.g. an XOR operation) of the third symbol string and the symbols corresponding to the fourth basis set or the second validly received set of secret symbols. In this manner, the second device is able to infer, using the fourth set of secret symbols, the symbols of the first device that correspond the third basis set. Since the both the first and the second device know, using the symmetric key, common symbol numbers of the validly received symbols, they simply discard all the rest of the symbols to obtain an identical set of symbols for forming a quantum key.

In the embodiment described above the server may comprise a single server or network of servers. In some examples the functionality of the server may be provided by a network of servers distributed across a geographical area, such as a worldwide distributed network of servers, and a user may be connected to an appropriate one of the network of servers based upon a user location.

The above description discusses embodiments of the invention with reference to a single user for clarity. It will be understood that in practice the system may be shared by a plurality of users, and possibly by a very large number of users simultaneously.

The embodiments described above are fully automatic. In some examples a user or operator of the system may manually instruct some steps of the method to be carried out.

In the described embodiments of the invention the system may be implemented as any form of a computing and/or electronic device. Such a device may comprise one or more processors which may be microprocessors, controllers or any other suitable type of processors for processing computer executable instructions to control the operation of the device in order to gather and record routing information. In some examples, for example where a system on a chip architecture is used, the processors may include one or more fixed function blocks (also referred to as accelerators) which implement a part of the method in hardware (rather than software or firmware). Platform software comprising an operating system or any other suitable platform software may be provided at the computing-based device to enable application software to be executed on the device.

Various functions described herein can be implemented in hardware, software, or any combination thereof. If implemented in software, the functions can be stored on or transmitted over as one or more instructions or code on a computer-readable medium. Computer-readable media may include, for example, computer-readable storage media. Computer-readable storage media may include volatile or non-volatile, removable or non-removable media implemented in any method or technology for storage of information such as computer readable instructions, data structures, program modules or other data. A computer-readable storage media can be any available storage media that may be accessed by a computer. By way of example, and not limitation, such computer-readable storage media may comprise RAM, ROM, EEPROM, flash memory or other memory devices, CD-ROM or other optical disc storage, magnetic disc storage or other magnetic storage devices, or any other medium that can be used to carry or store desired program code in the form of instructions or data structures and that can be accessed by a computer. Disc and disk, as used herein, include compact disc (CD), laser disc, optical disc, digital versatile disc (DVD), floppy disk, and blu-ray disc (BD). Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, DSL, or wireless technologies such as infrared, radio, and microwave are included in the definition of communication medium. Combinations of the above should also be included within the scope of computer-readable media.

Alternatively, or in addition, the functionality described herein can be performed, at least in part, by one or more hardware logic components. For example, and without limitation, hardware logic components that can be used may include Field-programmable Gate Arrays (FPGAs), Application-Program-specific Integrated Circuits (ASICs), Application-Program-specific Standard Products (ASSPs), System-on-a-chip systems (SOCs), Complex Programmable Logic Devices (CPLDs), etc.

Although illustrated as a single system, it is to be understood that the computing device may be a distributed system. Thus, for instance, several devices may be in communication by way of a network connection and may collectively perform tasks described as being performed by the computing device.

Although illustrated as a local device it will be appreciated that the computing device may be located remotely and accessed via a network or other communication link (for example using a communication interface).

The term ‘computer’ is used herein to refer to any device with processing capability such that it can execute instructions. Those skilled in the art will realise that such processing capabilities are incorporated into many different devices and therefore the term ‘computer’ includes PCs, servers, mobile telephones, personal digital assistants and many other devices.

Those skilled in the art will realise that storage devices utilised to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realise that by utilising conventional techniques known to those skilled in the art that all, or a portion of the software instructions may be carried out by a dedicated circuit, such as a DSP, programmable logic array, or the like.

It will be understood that the benefits and advantages described above may relate to one embodiment or may relate to several embodiments. The embodiments are not limited to those that solve any or all of the stated problems or those that have any or all of the stated benefits and advantages. Variants should be considered to be included into the scope of the invention.

Any reference to ‘an’ item refers to one or more of those items. The term ‘comprising’ is used herein to mean including the method steps or elements identified, but that such steps or elements do not comprise an exclusive list and a method or apparatus may contain additional steps or elements.

As used herein, the terms “component” and “system” are intended to encompass computer-readable data storage that is configured with computer-executable instructions that cause certain functionality to be performed when executed by a processor. The computer-executable instructions may include a routine, a function, or the like. It is also to be understood that a component or system may be localized on a single device or distributed across several devices.

Further, as used herein, the term “exemplary” is intended to mean “serving as an illustration or example of something”.

Further, to the extent that the term “includes” is used in either the detailed description or the claims, such term is intended to be inclusive in a manner similar to the term “comprising” as “comprising” is interpreted when employed as a transitional word in a claim.

The figures illustrate exemplary methods. While the methods are shown and described as being a series of acts that are performed in a particular sequence, it is to be understood and appreciated that the methods are not limited by the order of the sequence. For example, some acts can occur in a different order than what is described herein. In addition, an act can occur concurrently with another act. Further, in some instances, not all acts may be required to implement a method described herein.

Moreover, the acts described herein may comprise computer-executable instructions that can be implemented by one or more processors and/or stored on a computer-readable medium or media. The computer-executable instructions can include routines, sub-routines, programs, threads of execution, and/or the like. Still further, results of acts of the methods can be stored in a computer-readable medium, displayed on a display device, and/or the like.

The order of the steps of the methods described herein is exemplary, but the steps may be carried out in any suitable order, or simultaneously where appropriate. Additionally steps may be added or substituted in, or individual steps may be deleted from any of the methods without departing from the scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. What has been described above includes examples of one or more embodiments. It is, of course, not possible to describe every conceivable modification and alteration of the above devices or methods for purposes of describing the aforementioned aspects, but one of ordinary skill in the art can recognize that many further modifications and permutations of various aspects are possible. Accordingly, the described aspects are intended to embrace all such alterations, modifications, and variations that fall within the scope of the appended claims.

1-27. (canceled)

28. A computer-implemented method of quantum key distribution between a first device, a second device, and an intermediary device, the method comprising steps of:
transmitting, by the intermediary device, a first secret symbol string over a first quantum channel to the first device, wherein each symbol of the first secret symbol string is modulated by a basis state randomly selected from a set of bases;
transmitting, by the intermediary device, a second secret symbol string over a second quantum channel to the second device, wherein each symbol of the second secret symbol string is modulated by a basis state randomly selected from the set of bases;
demodulating, by the first device, the first secret symbol string, wherein each symbol of the first secret symbol string is demodulated by a basis state randomly selected from the set of bases;
demodulating, by the second device, the second secret symbol string, wherein each symbol of the second secret symbol string is demodulated by a basis state randomly selected from the set of bases;
transmitting, from the first device to the intermediary device over a first communication channel first reported symbol numbers, wherein the first reported symbol numbers comprise symbol numbers of symbols of the first secret symbol string that were successfully received by the first device, and symbol numbers of one or more symbols of the first secret symbol string that were not successfully received by the first device;
transmitting from the second device to the intermediary device over a second communication channel symbol second reported symbol numbers, wherein the second reported symbol numbers comprise symbol numbers of the second secret symbol string that were successfully received by the second device, and symbol numbers of one or more symbols of the second secret symbol string that were not successfully received by the second device;
transmitting from the intermediary device to the first device over the first communication channel a first basis state set corresponding to the first reported symbol numbers, the first basis state comprising the basis states used to modulate the symbols of the first secret symbol string, such that the first device can identify validly received symbols from the first secret symbol string to produce a first validly received set of secret symbols;
transmitting from the intermediary device to the second device over the second communication channel a second basis state set corresponding to the second reported symbol numbers, the second basis state set comprising the basis states used to modulate the symbols of the second secret symbol string, such that the second device can identify the validly received symbols from the second secret symbol string to produce a second validly received set of secret symbols;
generating, by the intermediary device, a third symbol string using the first secret symbol string and the second secret symbol string, wherein the third symbol string is generated by:
generating a first set of secret symbols comprising symbols of the first secret symbol string that correspond to the first reported symbol numbers;
generating a second set of secret symbols comprising symbols of the second secret symbol string that correspond to the second reported symbol numbers; and
generating the third symbol string using the first set of secret symbols and the second set of secret symbols;
transmitting from the intermediary device to the second device over the second communication channel the third symbol string, wherein the first device and the second device perform a quantum key exchange based on:
generating, by the second device, a fourth set of secret symbols using the third symbol string and symbols corresponding to the second reported symbol numbers or the second validly received set of secret symbols; wherein the fourth set of secret symbols comprise the symbols of the first device that correspond the first reported symbol numbers;
sharing, between the first and the second device over a third communication channel, symbol numbers of the validly received symbols of the received first and the second set of secret symbols; and
performing a symbol sifting operation by the first device and second device, respectively, by identifying validly received symbols of both the first and second devices that have a common symbol position, wherein the second device is able to infer, using the fourth set of secret symbols, the validly received symbols of the first device, such that both the first and the second device obtain identical symbols for forming a quantum key.

29. The method of claim 28, wherein a symbol is a bit.

30. The method of claim 28, wherein the intermediary device comprises two or more nodes.

31. The method of claim 30, wherein each node is configured to receive data from an adjacent node and/or the first or the second device.

32. The method of claim 30, wherein each node is configured to transmit data to an adjacent node and/or the first or the second device.

33. The method of claim 32, wherein the two or more nodes comprise:
a first node which transmits the first secret symbol string and the first basis state set to the first device, and receives the first reported symbol numbers transmitted from the first device; and
a second node which transmits the second secret symbol string, the second basis state set, and the third symbol string to the second device, receives the second reported symbol numbers transmitted from the second device, and generates the third symbol string;
wherein the first node transmits the first set of secret symbols, or the first secret symbol string and the first reported symbol numbers, to the second node.

34. The method of claim 28, wherein the third symbol string is generated based on performing an XOR operation of symbols comprising the first set of secret symbols and the second set of secret symbols.

35. The method of claim 28, wherein the third symbol string is generated based on performing a one-time pad encryption operations(s) of symbols comprising first set of secret symbols and the second set of secret symbols.

36. The method of claim 28, wherein the third symbol string is generated based on performing an operation for obfuscating one or more symbols of the first set of secret symbols using the second set of secret symbols.

37. The method of claim 28, wherein the fourth set of secret symbols is generated based on performing an XOR operation of symbols comprising the third symbol string and the symbols corresponding to the second reported symbol numbers or the second validly received set of secret symbols.

38. The method of claim 28, wherein the fourth set of secret symbols is generated based on performing a one-time pad decryption operations(s) of symbols comprising the third symbol string and the symbols corresponding to the second reported symbol numbers or the second validly received set of secret symbols.

39. The method of claim 28, wherein the fourth set of secret symbols is generated based on performing an operation for extracting one or more symbols corresponding to the second reported symbol numbers or second validly received set of secret symbols using the third symbol string.

40. A computer-implemented method of quantum key distribution between a first device, a second device, and an intermediary device, the method comprising steps of:
transmitting, by the intermediary device, a first secret symbol string over a first quantum channel to the first device, wherein each symbol of the first secret symbol string is modulated by a basis state randomly selected from a set of bases;
transmitting, by the intermediary device, a second secret symbol string over a second quantum channel to the second device, wherein each symbol of the second secret symbol string is modulated by a basis state randomly selected from a the set of bases;
demodulating, by the first device, the first secret symbol string, wherein each symbol of the first secret symbol string is demodulated by a basis state randomly selected from the set of bases;
demodulating, by the second device, the second secret symbol string, wherein each symbol of the second secret symbol string is demodulated by a basis state randomly selected from the set of bases;
transmitting, from the first device to the intermediary device over a first communication channel first reported symbol numbers, wherein the first reported symbol numbers comprise symbol numbers of symbols of the first secret symbol string that were successfully received by the first device, and symbol numbers of one or more symbols of the first secret symbol string that were not successfully received by the first device;
transmitting from the second device to the intermediary device over a second communication channel symbol second reported symbol numbers, wherein the second reported symbol numbers comprise symbol numbers of the second secret symbol string that were successfully received by the second device, and symbol numbers of one or more symbols of the second secret symbol string that were not successfully received by the second device;
transmitting from the intermediary device to the first device over the first communication channel a first basis state set corresponding to the first reported symbol numbers, the first basis state set comprising the basis states used to modulate the symbols of the first secret symbol string, such that the first device can identify validly received symbols from the first secret symbol string to produce a first validly received set of secret symbols;
transmitting from the intermediary device to the second device over the second communication channel a second basis state set corresponding to the second reported symbol numbers, the second basis state set comprising the basis states used to modulate the symbols of the second secret symbol string, such that the second device can identify the validly received symbols from the second secret symbol string to produce a second validly received set of secret symbols, wherein
the first and the second device use a shared symmetric key to generate common symbol positions to position their validly received symbols;
transmitting, from the first device to the intermediary device via the first communication channel a third basis state set, wherein the third basis state set comprises the basis states used to modulate the validly received symbols of the first secret symbol string, and one or more basis states corresponding to symbols from the first secret symbol string that were successfully received, but not validly received, and/or one or more basis states corresponding to symbols from the first secret symbol string that were not successfully received;
transmitting from the second device to the intermediary device via the second communication channel a fourth basis state set, wherein the fourth basis state set comprises the basis states used to modulate the validly received symbols of the second secret symbol string, and one or more basis states corresponding to symbols from the second secret symbol string that were successfully received, but not validly received, and/or one or more basis states corresponding to symbols from the second secret symbol string that were not successfully received;
generating, by the intermediary device, a third symbol string using the first secret symbol string and the second secret symbol string, wherein the third symbol string is generated by:
generating a first set of secret symbols comprising symbols of the first secret symbol string that correspond to the third basis set;
generating a second set of secret symbols comprising symbols of the second secret symbol string that correspond to fourth basis set;
shifting the first and the second set of secret symbols to produce, respectively, a first and a second set of shifted secret symbols; and
generating the third symbol string using the first and a second set of shifted secret symbols; and
transmitting from the intermediary device to the second device over the second communication channel the third symbol string; and
generating, by the second device, a fourth set of secret symbols using the third symbol string and the symbols corresponding to the fourth basis set or the second validly received set of secret symbols, wherein the second device is able to infer, using the fourth set of secret symbols, the symbols of the first device that correspond the third basis set, such that both the first and the second device obtain identical symbols for forming a quantum key.

41. The method of claim 40, wherein a symbol is a bit.

42. The method of claim 40, wherein the intermediary device comprises one or more nodes.

43. The method of claim 42, wherein each node is configured to receive data from an adjacent node and/or the first or the second device.

44. The method of claim 42, wherein each node is configured to transmit data to an adjacent node and/or the first or the second device.

45. The method of claim 44, wherein the one or more nodes comprise:
a first node which transmits the first secret symbol string and the first basis state set to the first device, and receives the first reported symbol numbers and the third basis set transmitted from the first device; and
a second node which transmits the second secret symbol string, the second basis state set, and the third symbol string to the second device, receives the second reported symbol numbers and the fourth basis set transmitted from the second device, and generates the third symbol string;
wherein the first node transmits the first set of secret symbols, or the first symbol string and the third basis set, to the second node.

46. The method of claim 40, wherein the third symbol string is generated based on performing an XOR operation of symbols comprising the first set of shifted secret symbols and the second shifted set of secret symbols.

47. The method of claim 40, wherein the third symbol string is generated based on performing a one-time pad encryption operations(s) of symbols comprising first set of shifted secret symbols and the second set of shifted secret symbols.
